(19) United States
(12) Patent Application Publication
(10) Pub. No.: US 2026/0203998 A1
(43) Pub. Date: Jul. 16, 2026

(54) THREE-DIMENSIONAL MODEL GENERATION APPARATUS, THREE-DIMENSIONAL MODEL GENERATION METHOD, AND COMPUTER-READABLE RECORDING MEDIUM

(71) Applicant: NEC Corporation, Tokyo (JP)

(72) Inventors: Jiro ABE, Tokyo (JP); Kazumine Ogura, Tokyo (JP); Hiroshi Matsumoto, Tokyo (JP)

(73) Assignee: NEC Corporation, Tokyo (JP)

(21) Appl. No.: 19/439,695

(22) Filed: Jan. 5, 2026

(30) Foreign Application Priority Data
Jan. 16, 2025 (JP) 2025-006154

(51) Int. Cl. G06T 15/20; G06T 7/579; G06T 7/70

(52) U.S. Cl. CPC G06T 15/20; G06T 7/579; G06T 7/70; G06T 2207/10028; G06T 2207/20081; G06T 2207/30244

(57) ABSTRACT

A three-dimensional model generation apparatus includes a virtual camera arrangement unit that arranges a plurality of virtual cameras in such a way as to image a first three-dimensional model in a three-dimensional space, a rendering processing unit that renders the first three-dimensional model using a position and a posture of each one of the plurality of virtual cameras to generate a plurality of rendering images, and a three-dimensional model generation unit that generates a second three-dimensional model using the position and the posture of each one of the plurality of virtual cameras and each one of the plurality of rendering images.

This application is based upon and claims the benefit of priority from Japanese patent application No. 2025-006154, filed on January 16, 2025, the disclosure of which is incorporated herein in its entirety by reference.

### TECHNICAL FIELD

The present disclosure relates to a technology for handling a highly accurate three-dimensional model.

### BACKGROUND ART

In recent years, development of a three-dimensional laser scanner has facilitated generation of a three-dimensional model of an object to be measured. The three-dimensional model is generated with extremely high accuracy, and an error between a distance measured on the three-dimensional model and a distance measured on a real object is extremely small. Thus, the generated three-dimensional model is utilized in various fields such as construction, surveys, and inspections of infrastructure structures.

When the three-dimensional model is in a state of being generated by the three-dimensional laser scanner, a part of a point cloud may be missing, and in this case, there is a deviation from the real object. Thus, a technology for complementing a missing point cloud using a machine learning model has been disclosed (see, for example, JP 2024-68190 A).

### SUMMARY

However, in a highly accurate three-dimensional model, an amount of data is extremely large, which results in a problem that a load in data processing is large. Since the load in data processing is large, a high-performance computing machine is required, and a cost of the computing machine for handling three-dimensional models becomes extremely high.

It is an object of the present disclosure to reduce the amount of data while suppressing a decrease in accuracy in a three-dimensional model.

In order to achieve the above object, a three-dimensional model generation apparatus according to one aspect of the present disclosure includes

a virtual camera arrangement unit that arranges a plurality of virtual cameras in such a way as to image a first three-dimensional model in a three-dimensional space,

a rendering processing unit that renders the first three-dimensional model using a position and a posture of each one of the plurality of virtual cameras to generate a plurality of rendering images, and

a three-dimensional model generation unit that generates a second three-dimensional model using the position and the posture of each one of the plurality of virtual cameras and each one of the plurality of rendering images

In order to achieve the above object, an image display apparatus according to one aspect of the present disclosure includes

a data selection unit that selects, in accordance with a user's operation that has been input, one of a first three-dimensional model or a second three-dimensional model that has been created for the same target as the first three-dimensional model and has a smaller amount of data that the first three-dimensional model,

a processing execution unit that executes processing corresponding to the operation on the selected three-dimensional model, and

a presentation unit that presents a result of the processing.

In order to achieve the above object, a three-dimensional model generation method according to one aspect of the present disclosure includes

a virtual camera arrangement step of arranging a plurality of virtual cameras in such a way to image a first three-dimensional model in a three-dimensional space,

a rendering processing step of rendering the first three-dimensional model using a position and a posture of each of the plurality of virtual cameras to generate a plurality of rendering images, and

a three-dimensional model generation step of generating a second three-dimensional model using the position and the posture of each one of the plurality of virtual cameras and each one of the plurality of rendering images.

In order to achieve the above object, an image display method according to one aspect of the present disclosure includes

a data selection step of selecting, in accordance with a user's operation that has been input, one of a first three-dimensional model or a second three-dimensional model that has been created for the same target as the first three-dimensional model and has a smaller amount of data than the first three-dimensional model,

a processing execution step of executing processing corresponding to the operation on the selected three-dimensional model, and

a presentation step of presenting a result of the processing.

Furthermore, in order to achieve the above object, a first computer-readable recording medium according to one aspect of the present disclosure

records a program including an instruction for causing

a computer to execute

a virtual camera arrangement step of arranging a plurality of virtual cameras in such a way as to image a first three-dimensional model in a three-dimensional space,

a rendering processing step of rendering the first three-dimensional model using a position and a posture of each one of the plurality of virtual cameras to generate a plurality of rendering images, and

a three-dimensional model generation step of generating a second three-dimensional model using the position and the posture of each one of the plurality of virtual cameras and each of the plurality of rendering images.

Furthermore, in order to achieve the above object, a second computer-readable recording medium according to one aspect of the present disclosure

records a program including an instruction for causing

a computer to execute

a data selection step of selecting, in accordance with a user's operation that has been input, one of a first three-dimensional model or a second three-dimensional model that has been created for the same target as the first three-dimensional model and has a smaller amount of data than the first three-dimensional model,

a processing execution step of executing processing corresponding to the operation on the selected three-dimensional model, and

a presentation step of presenting a result of the processing.

According to the present disclosure, it is possible to reduce the amount of data while suppressing a decrease in accuracy in a three-dimensional model.

### BRIEF DESCRIPTION OF THE DRAWINGS

FIG. 1 is a configuration diagram illustrating a schematic configuration of an example of a three-dimensional model generation apparatus;

FIG. 2 is a configuration diagram more specifically illustrating the configuration of the example of the three-dimensional model generation apparatus;

FIG. 3 is a schematic diagram illustrating an example of arrangement of virtual cameras;

FIG. 4 is a schematic diagram illustrating another example of the arrangement of the virtual cameras;

FIG. 5 is a flowchart illustrating an example of an operation of the three-dimensional model generation apparatus;

FIG. 6 is a configuration diagram illustrating a configuration of an example of an image display apparatus;

FIG. 7 is a configuration diagram more specifically illustrating a configuration of an example of the image display apparatus;

FIG. 8 is a flowchart illustrating an example of an operation of the image display apparatus;

FIG. 9 illustrates a configuration of another example of the image display apparatus; and

FIG. 10 is a block diagram illustrating an example of a computer that implements the three-dimensional model generation apparatus and the image display apparatus.

### EXAMPLE EMBODIMENT

### First Example Embodiment

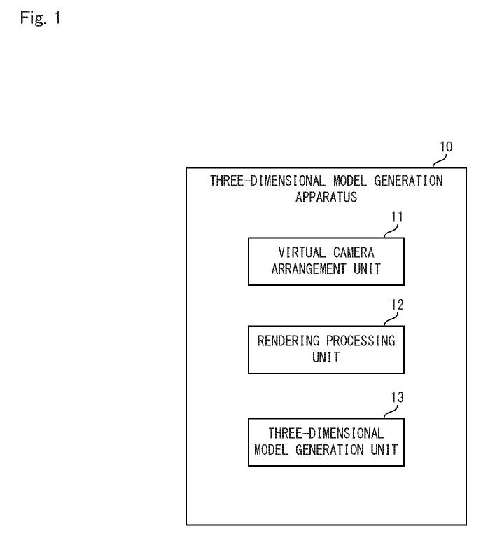

Hereinafter, in a first example embodiment, an example of a three-dimensional model generation apparatus, a three-dimensional model generation method, and a program will be described with reference to FIGS. 1 to 5.

### Apparatus Configuration

First, a schematic configuration of an example of the three-dimensional model generation apparatus will be described with reference to FIG. 1. FIG. 1 is a configuration diagram illustrating a schematic configuration of an example of the three-dimensional model generation apparatus.

A three-dimensional model generation apparatus 10 illustrated in FIG. 1 is an apparatus for generating, from a highly accurate three-dimensional model, another three-dimensional model having a smaller amount of data. As illustrated in FIG. 1, the three-dimensional model generation apparatus 10 includes a virtual camera arrangement unit 11, a rendering processing unit 12, and a three-dimensional model generation unit 13.

The virtual camera arrangement unit 11 arranges a plurality of virtual cameras in such a way as to image a first three-dimensional model in a three-dimensional space. The rendering processing unit 12 generates a plurality of rendering images by rendering the first three-dimensional model using a position and a posture of each one of the plurality of virtual cameras. The three-dimensional model generation unit 13 generates a second three-dimensional model using the position and the posture of each one of the plurality of virtual cameras and each one of the plurality of rendering images.

As described above, the three-dimensional model generation apparatus 10 generates, from a rendering image of an original three-dimensional model, another three-dimensional model. Then, the second three-dimensional model generated in this way has been created for the same target as the first three-dimensional model, but is a three-dimensional model having a smaller amount of data than the first three-dimensional model. Thus, according to the three-dimensional model generation apparatus 10, it is possible to reduce the amount of data while suppressing a decrease in accuracy in a three-dimensional model.

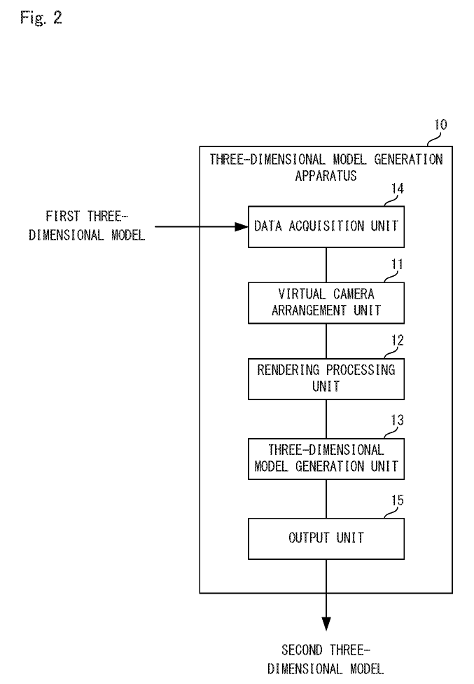

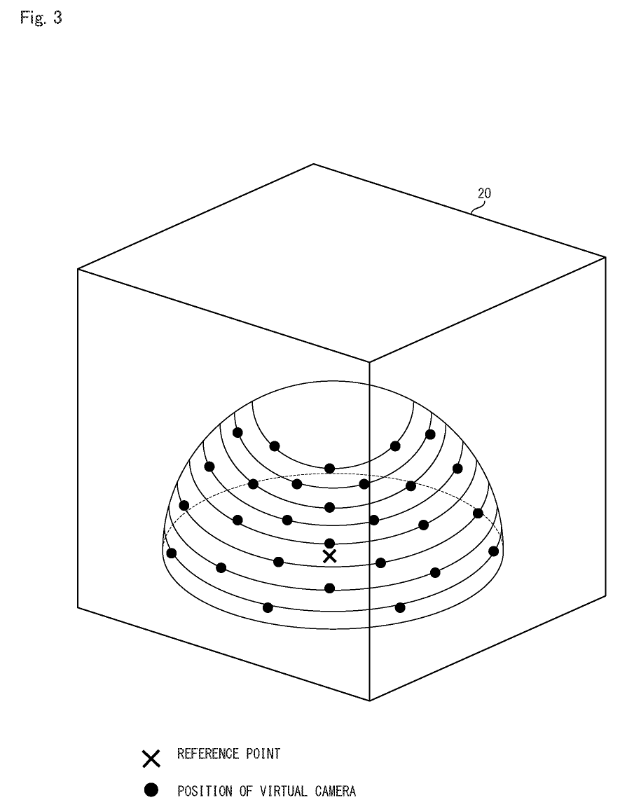

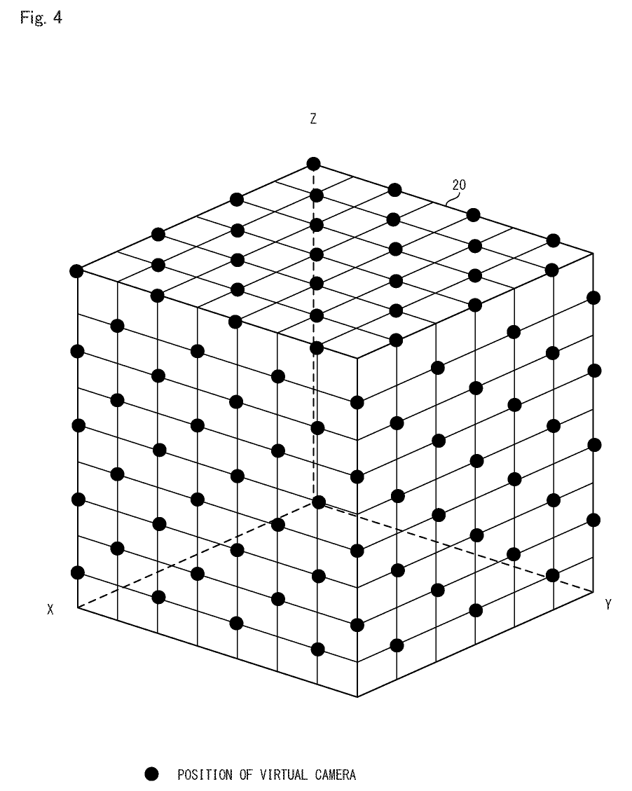

Next, a configuration and a function of the three-dimensional model generation apparatus 10 will be more specifically described with reference to FIGS. 2 to 4. FIG. 2 is a configuration diagram more specifically illustrating the configuration of the example of the three-dimensional model generation apparatus. FIG. 3 is a schematic diagram illustrating an example of arrangement of the virtual cameras. FIG. 4 is a schematic diagram illustrating another example of the arrangement of the virtual camera.

As illustrated in FIG. 2, the three-dimensional model generation apparatus 10 includes a data acquisition unit 14 and an output unit 15 in addition to the virtual camera arrangement unit 11, the rendering processing unit 12, and the three-dimensional model generation unit 13 illustrated in FIG. 1.

The data acquisition unit 14 acquires a first three-dimensional model from an external file server, storage, or the like. The first three-dimensional model is, for example, three-dimensional point cloud data generated using a three-dimensional laser scanner or the like.

The three-dimensional laser scanner includes a depth sensor such as a LiDAR and an imaging camera. With this configuration, the three-dimensional laser scanner executes scanning by the depth sensor and capturing of an image by the imaging camera, and generates three-dimensional point cloud data of an object and image data of the captured image. The three-dimensional laser scanner generates final three-dimensional point cloud data by pasting the image data to the generated three-dimensional point cloud data.

The three-dimensional point cloud data generated in this way is an extremely highly accurate three-dimensional model, and the amount of data becomes extremely large as described above. That is, the first three-dimensional model is a three-dimensional model with high accuracy and an extremely large amount of data.

In the example embodiment, the virtual camera arrangement unit 11 arranges the plurality of virtual cameras in such a way that the first three-dimensional model is within a field of view of rendering. Specifically, as illustrated in FIG. 3, for example, the virtual camera arrangement unit 11 sets a predetermined position in a three-dimensional space 20 as a reference point, and determines the positions of the virtual cameras in such a way that each of a distance from this reference point, a horizontal angle, and an elevation angle is incremented by a predetermined value. Furthermore, the virtual camera arrangement unit 11 sets the postures of the virtual cameras in such a way that an imaging direction of each virtual camera is a direction toward the reference point.

In another example, as illustrated in FIG. 4, the virtual camera arrangement unit 11 determines the position of each virtual camera in such a way as to cover XYZ coordinates in the three-dimensional space 20 in a lattice pattern. Furthermore, in this case, the virtual camera arrangement unit 11 sets, for each virtual camera, the imaging direction of the virtual camera to a predetermined direction (any one of six directions including front, back, left, right, up, and down). In the determination of the positions of the virtual cameras, intervals between the virtual cameras in an X direction, a Y direction, and a Z direction may be the same or may be different.

The virtual camera arrangement unit 11 can exclude a position where the shortest distance from the virtual camera to the first three-dimensional model is equal to or less than a predetermined value. This is to prevent a rendering image from becoming a local image of the first three-dimensional model.

Furthermore, the virtual camera arrangement unit 11 can arrange a part or all of the plurality of virtual cameras in such a way that a portion other than the first three-dimensional model in the three-dimensional space is included in a part or all of the plurality of rendering images, that is, the portion other than the first three-dimensional model is also imaged.

For example, it is assumed that the first three-dimensional model is a three-dimensional model showing just an inside of a room in a building. In this case, assuming that the virtual cameras are arranged in such a way as to image just the inside of the room, it is not possible to determine whether a first three-dimensional model showing an outside of the room exists in processing of the three-dimensional model generation unit 13. However, in this case, assuming that a virtual camera is arranged also outside the room in such a way that the portion other than the first three-dimensional model (outside the room) can be imaged, information indicating that no first three-dimensional model exists outside the room is added. As a result, an area where the first three-dimensional model exists is clarified, and the above-described determination can be made in the processing of the three-dimensional model generation unit 13.

In the example embodiment, the rendering processing unit 12 executes rendering on three-dimensional point cloud data, which is a first three-dimensional model, by using the position and the posture of each one of the plurality of virtual cameras, and generates a rendering image for each virtual camera as described above. Examples of a specific technique of the rendering include an existing technique.

The rendering processing unit 12 can execute rendering assuming that each point constituting the three-dimensional point cloud data is a solid. Specifically, in a case where the first three-dimensional model is three-dimensional point cloud data, the rendering processing unit 12 assumes that each point included in the point cloud data is a sphere or an ellipsoid having a size, and executes rendering under the assumption.

In this case, in the rendering image, a blank area in the three-dimensional point cloud data is filled in a pseudo manner. As a result, the three-dimensional model generation unit 13 can stably generate a second three-dimensional model. Furthermore, in the second three-dimensional model, spatial continuity increases, and this results in a reduction in data capacity.

Furthermore, the rendering processing unit 12 determines the size of the sphere or the ellipsoid described above based on spacing in the three-dimensional point cloud data. For example, the rendering processing unit 12 sets a radius of the sphere to root three times the spacing. In this case, rendering can be performed in such a way that neighboring spheres are in contact with each other. The rendering processing unit 12 can deform a sphere into an ellipsoid along a normal vector of the sphere, and in this case, a surface of the object is more accurately represented in the rendering image.

In the example embodiment, after internal parameters of the cameras in rendering have been determined, the rendering processing unit 12 passes the determined internal parameters to the three-dimensional model generation unit 13. Examples of the internal parameters include, but are not limited to, an image size and a focal length. Examples of the internal parameters include internal parameters of actual cameras such as cameras built in smartphones or the like. Furthermore, the internal parameters may be internal parameters of the cameras used for imaging the target (real object) of the first three-dimensional model.

Furthermore, the rendering processing unit 12 can also generate a mask image or a depth image in addition to the rendering image. The mask image is information indicating whether each pixel constituting the rendering image represents a space where nothing exists. The depth image is information representing a depth from a camera position for each pixel constituting the rendering image. Since the depth image takes a specific value in a case where the pixel represents a space where nothing exists, the depth image also includes information as a mask image.

Such a mask image and depth image are used, for example, when the three-dimensional model generation unit 13 generates a second three-dimensional model, to determine the area where the second three-dimensional model exists in the entire three-dimensional space.

In the example embodiment, the three-dimensional model generation unit 13 generates a second three-dimensional model by inputting the position and the posture of each one of the plurality of virtual cameras and each one of the plurality of rendering images to a machine learning model capable of generating a three-dimensional model.

Specifically, the three-dimensional model generation unit 13 uses a technique for constructing a three-dimensional model from multi-view photographic images using a machine learning model, such as Neural Radiance Fields (NeRF) or Gaussian Splatting. In this case, the three-dimensional model generation unit 13 applies multi-view rendering images to the machine learning model instead of the multi-view photographic images. In such a technique, in addition to the rendering images, the mask image and the depth image described above may be used as auxiliary information.

In the above-described technique, the three-dimensional model generation unit 13 first executes Structure from Motion (SfM) using the multi-view rendering images to generate three-dimensional point cloud data as an initial value, and generates a second three-dimensional model based on the generated three-dimensional point cloud data. In this case, the three-dimensional model generation unit 13 may generate three-dimensional point cloud data as an initial value by decimating data of the first three-dimensional model instead of executing SfM.

The three-dimensional model generation unit 13 can also generate a second three-dimensional model without using a machine learning model. Examples of a method for the generation in this case include SfM.

The output unit 15 outputs the second three-dimensional model generated by the three-dimensional model generation unit 13 to an outside.

### Apparatus Operation

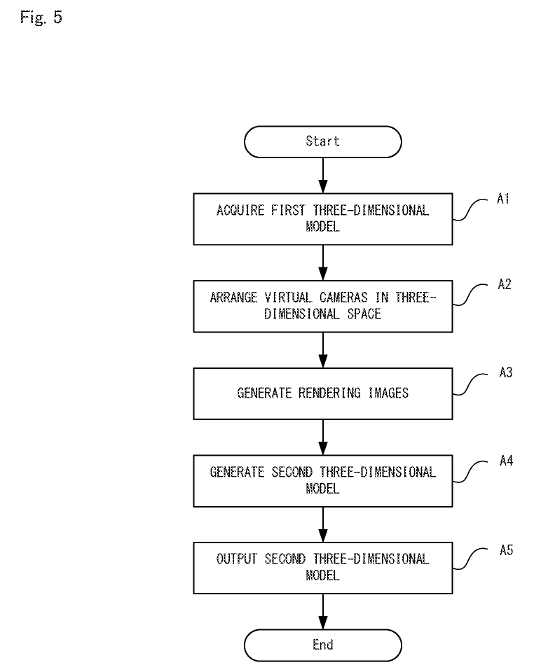

Next, an example of an operation of the three-dimensional model generation apparatus 10 will be described with reference to FIG. 5. FIG. 5 is a flowchart illustrating an example of an operation of the three-dimensional model generation apparatus. In the following description, FIGS. 1 to 4 will be appropriately referred to. In the first example embodiment, the three-dimensional model generation method is performed by operating the three-dimensional model generation apparatus 10. Thus, the following description of the operation of the three-dimensional model generation apparatus 10 serves as a substitute for description of the three-dimensional model generation method in the first example embodiment.

As illustrated in FIG. 5, first, the data acquisition unit 14 acquires a first three-dimensional model from an external file server, storage, or the like (step A1). The data acquisition unit 14 passes the acquired first three-dimensional model to the virtual camera arrangement unit 11.

Next, the virtual camera arrangement unit 11 arranges the plurality of virtual cameras in the three-dimensional space in such a way as to image the first three-dimensional model acquired in step A1 (step A2). Specifically, in step A2, the virtual camera arrangement unit 11 arranges the plurality of virtual cameras in such a way that the first three-dimensional model is within a field of view of rendering.

Next, the rendering processing unit 12 renders the first three-dimensional model using the position and the posture of each virtual camera arranged in step A2 to generate a plurality of rendering images (step A3).

Next, the three-dimensional model generation unit 13 generates a second three-dimensional model using the position and the posture of each one of the plurality of virtual cameras and each one of the plurality of rendering images (step A4). Specifically, in step A4, the three-dimensional model generation unit 13 generates the second three-dimensional model by inputting the position and the posture of each one of the plurality of virtual cameras and each one of the plurality of rendering images to a machine learning model capable of generating a three-dimensional model.

Next, the output unit 15 outputs the second three-dimensional model generated in step A4 to the outside (step A5).

As described above, in the example embodiment, a second three-dimensional model is generated from a highly accurate first three-dimensional model. As described above, the second three-dimensional model has been created for the same target as the first three-dimensional model, but is a three-dimensional model having a smaller amount of data than the first three-dimensional model. According to the example embodiment, it is possible to reduce the amount of data while suppressing a decrease in accuracy in a three-dimensional model. As a result, it is possible to lessen the load in data processing using a three-dimensional model (see a second example embodiment).

### Program

In the first example embodiment, examples of the program include a program for causing a computer to execute steps A1 to A5 illustrated in FIG. 5. The three-dimensional model generation apparatus 10 and the three-dimensional model generation method can be achieved by installing and executing the program in the computer. In this case, a processor of the computer functions as the virtual camera arrangement unit 11, the rendering processing unit 12, the three-dimensional model generation unit 13, the data acquisition unit 14, and the output unit 15, and performs processing. Examples of the computer include a smartphone and a tablet terminal device in addition to a general-purpose PC and a server computer.

In the first example embodiment, the program may be executed by a computer system constructed by a plurality of computers. In this case, for example, each computer may function as any of the virtual camera arrangement unit 11, the rendering processing unit 12, the three-dimensional model generation unit 13, the data acquisition unit 14, and the output unit 15.

### Second Example Embodiment

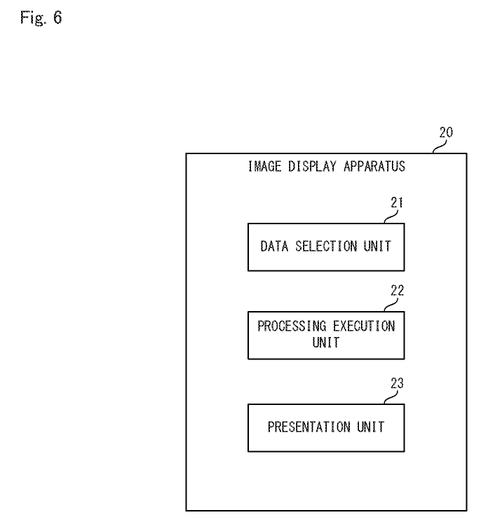

An example of an image display apparatus, an image display method, and a program in the second example embodiment will be described below with reference to FIGS. 6 to 8.

### Apparatus Configuration

First, a schematic configuration of an example of the image display apparatus will be described with reference to FIG. 6. FIG. 6 is a configuration diagram illustrating the configuration of the example of the image display apparatus.

An image display apparatus 20 illustrated in FIG. 6 is an apparatus for displaying a three-dimensional model as an image on a screen. As illustrated in FIG. 6, the image display apparatus 20 includes a data selection unit 21, a processing execution unit 22, and a presentation unit 23.

The data selection unit 21 selects one of a first three-dimensional model or a second three-dimensional model in accordance with a user's operation that has been input. The first three-dimensional model is a highly accurate three-dimensional model as described in the first example embodiment. As described in the first example embodiment, the second three-dimensional model is a three-dimensional model that has been created for the same target as the first three-dimensional model, but has a smaller amount of data than the first three-dimensional model.

The processing execution unit 22 executes, on the selected three-dimensional model, processing corresponding to the user's operation that has been input. The presentation unit 23 presents a result of the executed processing.

As described above, the image display apparatus 20 can select a three-dimensional model and execute processing in accordance with an operation input by the user, and display the result.

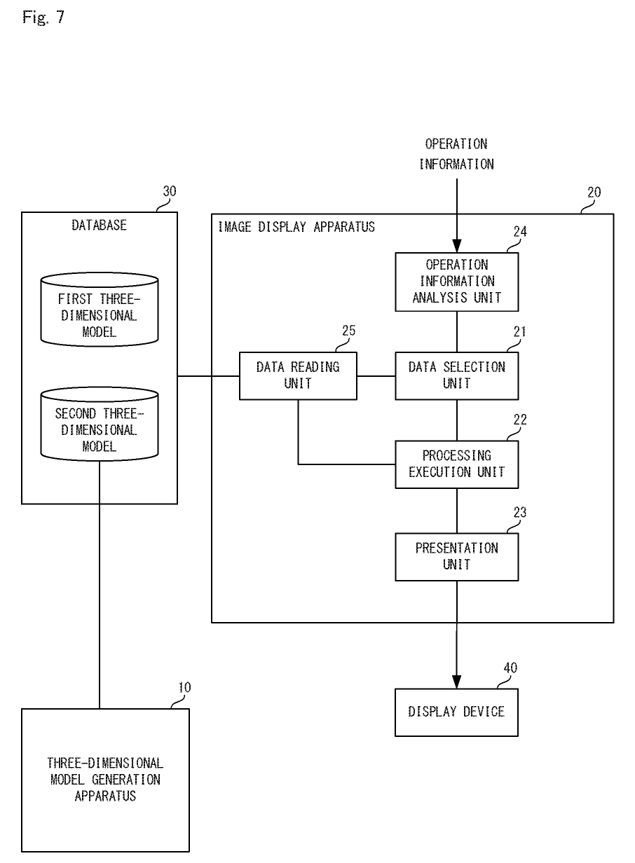

Next, the configuration and function of the image display apparatus 20 will be more specifically described with reference to FIG. 7. FIG. 7 is a configuration diagram more specifically illustrating a configuration of an example of the image display apparatus.

As illustrated in FIG. 7, in the example embodiment, the image display apparatus 20 is connected to a database 30 in a data-communicable manner. The database 30 may be built in the image display apparatus 20.

The database 30 stores the first three-dimensional model and the second three-dimensional model. The second three-dimensional model is a three-dimensional model generated by the three-dimensional model generation apparatus 10 described in the first example embodiment. In FIG. 7, 40 denotes a display device such as a liquid crystal display device.

As illustrated in FIG. 7, the image display apparatus 20 includes an operation information analysis unit 24 and a data reading unit 25 in addition to the data selection unit 21, the processing execution unit 22, and the presentation unit 23 illustrated in FIG. 6.

The operation information analysis unit 24 acquires operation information input by the user, and analyzes the acquired operation information. Specifically, the user inputs operation information for identifying a user's operation via an input device such as a touch pad, a mouse, or a keyboard on a user interface displayed on a screen of the display device 40.

Examples of the user's operation include an operation performed on a three- dimensional model such as rotation, move, enlargement, reduction, selection of a portion, switching between models, and the like of the three-dimensional model. Other examples of the user's operation include selection of an area in a three-dimensional space. Therefore, when acquiring operation information, the operation information analysis unit 24 first identifies an operation input by the user from the operation information, and inputs the identified operation to the data selection unit 21.

The operation information may include, for example, specific numerical values such as a central axis and a rotation amount in rotation, and a coordinate value of a pixel of a selected portion. In this case, the operation information analysis unit 24 extracts a numerical value from the operation information, and also inputs the extracted numerical value to the data selection unit 21.

In a case where the presentation unit 23 is displaying a three-dimensional model on the screen of the display device 40, the operation information analysis unit 24 may hold information regarding a viewpoint set in the display of the three-dimensional model.

The data reading unit 25 reads the first three-dimensional model and the second three-dimensional model from the database 30. The data reading unit 25 may read both the first three-dimensional model and the second three-dimensional model in advance, or may read just the three-dimensional model selected by the data selection unit 21.

Based on the operation identified by the operation information analysis unit 24, the data selection unit 21 selects one of the first and second three-dimensional models as a three-dimensional model to be operated.

Specifically, the data selection unit 21 selects the first three-dimensional model in a case where the identified operation is an operation in which accuracy is more important than processing speed, or in a case where the identified operation is an operation of displaying the first three-dimensional model. Examples of the operation in which accuracy is more important than processing speed include an operation of selecting a point or a portion in a three-dimensional model, and an operation in which the distance from the viewpoint in display of the three-dimensional model to the three-dimensional model is equal to or less than a predetermined threshold.

In a case where the first three-dimensional model is selected, the data selection unit 21 determines coordinates of an area to be operated in the first three-dimensional model. The coordinates are set, for example, by dividing XYZ coordinates in a lattice pattern at predetermined intervals in a three-dimensional space including the first three-dimensional model.

The data selection unit 21 selects the second three-dimensional model in a case where the identified operation is an operation in which processing speed is more important than accuracy. Examples of the operation in which processing speed is more important than accuracy include rotation, enlargement, and reduction of a three-dimensional model on the screen.

In a case where the second three-dimensional model is selected, the data selection unit 21 determines coordinates of a point or a portion to be operated, and determines an area including the determined coordinates of the point or the portion. Furthermore, for example, the area is determined in such a way as to be included in an angle of view at the time of display based on a position and a posture at the viewpoint in the display of the three-dimensional model.

The processing execution unit 22 executes processing corresponding to the operation identified by the operation information analysis unit 24 on the three-dimensional model selected by the data selection unit 21 in a virtual three-dimensional space. For example, in a case where the operation is an operation of selecting a point or a portion in a three-dimensional model and the first three-dimensional model has been selected, the processing execution unit 22 selects the selected point or portion in the first three-dimensional model. In a case where the operation is an operation of rotating a three-dimensional model and the second three-dimensional model has been selected, the processing execution unit 22 rotates the second three-dimensional model in accordance with the operation.

The presentation unit 23 displays a result of the processing on the screen of the display device 40. Specifically, in order to display, on the screen, the three-dimensional model processed in the virtual three-dimensional space by the processing execution unit 22, the presentation unit 23 creates image data to be displayed on the screen, and outputs the created image data to the display device 40. As a result, the processed three-dimensional model is displayed on the screen of the display device 40.

### Apparatus Operation

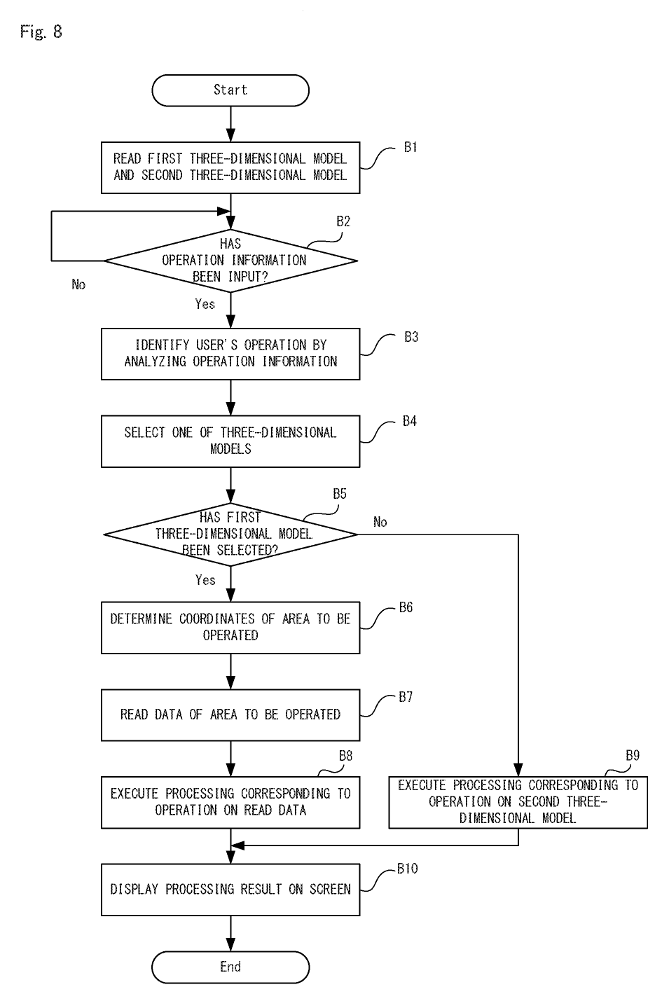

Next, an example of an operation of the image display apparatus 20 will be described with reference to FIG. 8. FIG. 8 is a flowchart illustrating an example of an operation of the image display apparatus. In the following description, FIGS. 6 and 7 will be appropriately referred to. In the second example embodiment, the image display method is performed by operating the image display apparatus 20. Thus, the following description of the operation of the image display apparatus 20 serves as a substitute for description of the image display method in the second example embodiment.

As illustrated in FIG. 8, first, the data reading unit 25 reads a first three-dimensional model and a second three-dimensional model from the database 30 (step B1).

Next, the operation information analysis unit 24 determines whether operation information has been input by a user (step B2). Specifically, the operation information analysis unit 24 determines whether the user has input operation information via an input device.

If a result of the determination in step B2 shows that no operation information has been input by the user, the operation information analysis unit 24 enters a standby state.

On the other hand, if the result of the determination in step B2 shows that operation information has been input by the user, the operation information analysis unit 24 acquires the operation information input by the user and analyzes the acquired operation information to identify the user's operation (step B3).

Next, based on the operation identified in step B3, the data selection unit 21 selects one of the first and second three-dimensional models as a three-dimensional model to be operated (step B4).

Next, the processing execution unit 22 determines whether the three-dimensional model selected in step B4 is the first three-dimensional model or the second three-dimensional model (step B5).

If a result of the determination in step B5 shows that the three-dimensional model selected in step B4 is the first three-dimensional model, the processing execution unit 22 determines the coordinates of the area to be operated in the first three-dimensional model (step B6).

Furthermore, after execution of step B6, the processing execution unit 22 reads data of the area to be operated based on the coordinates determined in step B6 (step B7).

Next, the processing execution unit 22 executes processing corresponding to the operation identified in Step B3 on the data read in Step B7 (Step B8).

On the other hand, if the result of the determination in step B5 shows that the three-dimensional model selected in step B4 is the second three-dimensional model, the processing execution unit 22 executes the processing corresponding to the operation identified in step B3 on the second three-dimensional model (step B9).

After execution of step B8 or B9, the presentation unit 23 displays a result of the processing on the screen of the display device 40 (step B10).

As described above, in the second example embodiment, a three-dimensional model is selected in accordance with an operation input by a user, processing is executed on the selected three-dimensional model, and the result is displayed. Thus, it is possible to perform the operation desired by the user while avoiding a processing delay due to an increase in a processing load in the apparatus.

### Program

In the second example embodiment, examples of the program include a program for causing a computer to execute steps B1 to B10 illustrated in FIG. 8. The image display apparatus 20 and the image display method can be achieved by installing and executing the program in the computer. In this case, a processor of the computer functions as the data selection unit 21, the processing execution unit 22, the presentation unit 23, the operation information analysis unit 24, and the data reading unit 25, and performs processing. Examples of the computer include a smartphone and a tablet terminal device in addition to a general-purpose PC and a server computer.

In the second example embodiment, the program may be executed by a computer system constructed by a plurality of computers. In this case, for example, each computer may function as any of the data selection unit 21, the processing execution unit 22, the presentation unit 23, the operation information analysis unit 24, and the data reading unit 25.

### Modification

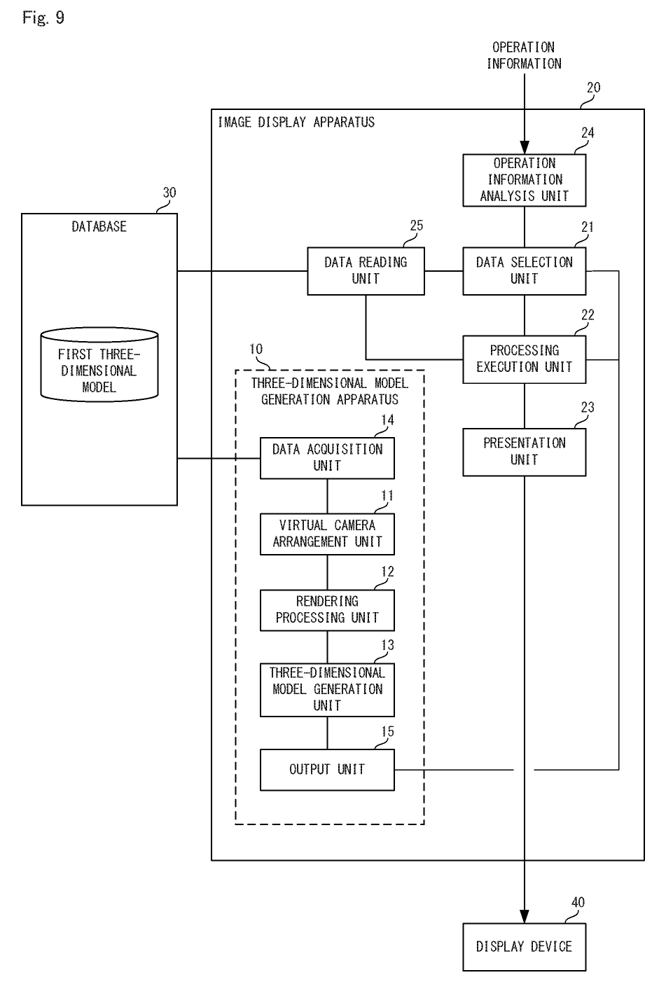

Here, a modification of the image display apparatus 20 will be described with reference to FIG. 9. FIG. 9 illustrates a configuration of another example of the image display apparatus.

As illustrated in FIG. 9, the image display apparatus 20 may include the three-dimensional model generation apparatus 10 therein. Specifically, in the modification, the image display apparatus 20 includes a virtual camera arrangement unit 11, a rendering processing unit 12, a three-dimensional model generation unit 13, a data acquisition unit 14, and an output unit 15, in addition to the configuration illustrated in FIG. 7.

In the modification, the data reading unit 25 reads just the first three-dimensional model from the database 30.

### Physical Configuration

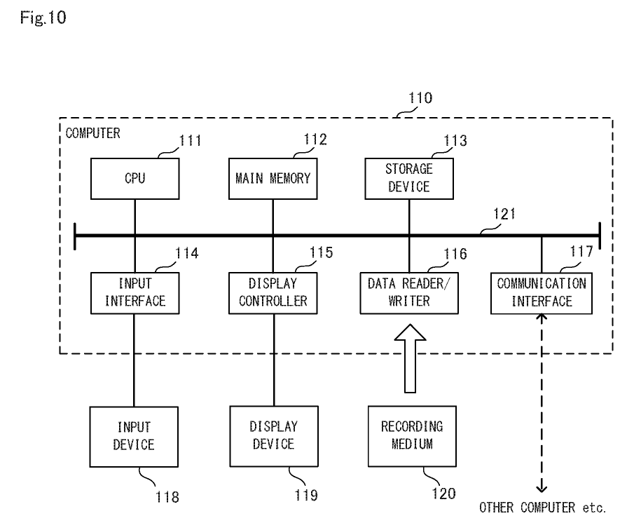

Here, a computer that implements the three-dimensional model generation apparatus or the image display apparatus by executing a program in the first and second example embodiments will be described with reference to FIG. 10. FIG. 10 is a block diagram illustrating an example of the computer that implements the three-dimensional model generation apparatus and the image display apparatus.

As illustrated in FIG. 10, a computer 110 includes a central processing unit (CPU) 111, a main memory 112, a storage device 113, an input interface 114, a display controller 115, a data reader/writer 116, and a communication interface 117. These units are connected via a bus 121 in such a way as to be able to perform data communication with each other.

The computer 110 may include a graphics processing unit (GPU) or a field-programmable gate array (FPGA), in addition to the CPU 111 or instead of the CPU 111. In this mode, the GPU or the FPGA can execute the program in the example embodiments.

The CPU 111 loads the program in the example embodiments, the program being stored in the storage device 113 and constituted by codes, into the main memory 112, and executes the codes in a predetermined order to perform various computations. The main memory 112 is typically a volatile storage device such as a dynamic random access memory (DRAM).

The program in the example embodiments is provided in a state of being stored in a computer-readable recording medium 120. The program in the present example embodiments may be distributed on the Internet connected via the communication interface 117.

Specific examples of the storage device 113 include a semiconductor storage device such as a flash memory in addition to a hard disk drive. The input interface 114 mediates data transmission between the CPU 111 and an input device 118 such as a keyboard and a mouse. The display controller 115 is connected to a display device 119, and controls display on the display device 119.

The data reader/writer 116 mediates data transmission between the CPU 111 and the recording medium 120, and reads a program from the recording medium 120 and writes a processing result in the computer 110 into the recording medium 120. The communication interface 117 mediates data transmission between the CPU 111 and another computer.

Specific examples of the recording medium 120 include a general-purpose semiconductor storage device such as Compact Flash (CF) (registered trademark) and Secure Digital (SD), a magnetic recording medium such as a flexible disk, and an optical recording medium such as a compact disk read only memory (CD-ROM).

The three-dimensional model generation apparatus and the image display apparatus can also be achieved by using hardware corresponding to each unit, for example, an electronic circuit, instead of the computer in which the program is installed. Furthermore, a part of the three-dimensional model generation apparatus and the image display apparatus may be achieved by a program, and the remaining part may be achieved by hardware. In the example embodiments, the computer is not limited to the computer illustrated in FIG. 10.

Some or all of the example embodiments described above can be represented by (Supplementary Note 1) to (Supplementary Note 21) described below, but are not limited to the following description.

### Supplementary Note 1

A three-dimensional model generation apparatus including:

a virtual camera arrangement unit that arranges a plurality of virtual cameras in such a way as to image a first three-dimensional model in a three-dimensional space;

a rendering processing unit that renders the first three-dimensional model using a position and a posture of each one of the plurality of virtual cameras to generate a plurality of rendering images; and

a three-dimensional model generation unit that generates a second three-dimensional model using the position and the posture of each one of the plurality of virtual cameras and each one of the plurality of rendering images.

### Supplementary Note 2

The three-dimensional model generation apparatus according to Supplementary Note 1, in which

the virtual camera arrangement unit arranges the plurality of virtual cameras in such a way that the first three-dimensional model is within a field of view of rendering.

### Supplementary Note 3

The three-dimensional model generation apparatus according to Supplementary Note 1, in which

the virtual camera arrangement unit arranges a part or all of the plurality of virtual cameras in such a way that a portion other than the first three-dimensional model in the three-dimensional space is included in a part or all of the plurality of rendering images.

### Supplementary Note 4

The three-dimensional model generation apparatus according to Supplementary Note 1, in which

the first three-dimensional model is three-dimensional point cloud data, and

the rendering processing unit executed rendering assuming that each point constituting the three-dimensional point cloud data is a solid.

### Supplementary Note 5

The three-dimensional model generation apparatus according to Supplementary Note 1, in which

the three-dimensional model generation unit generates the second three-dimensional model by inputting the position and the posture of each one of the plurality of virtual cameras and each of the plurality of rendering images to a machine learning model capable of generating a three-dimensional model.

### Supplementary Note 6

An image display apparatus including:

a data selection unit that selects, in accordance with a user's operation that has been input, one of a first three-dimensional model or a second three-dimensional model that has been created for the same target as the first three-dimensional model and has a smaller amount of data than the first three-dimensional model;

a processing execution unit that executes processing corresponding to the operation on the selected three-dimensional model; and

a presentation unit that presents a result of the processing.

### Supplementary Note 7

The image display apparatus according to Supplementary Note 6, further including:

a virtual camera arrangement unit that arranges a plurality of virtual cameras in such a way as to image the first three-dimensional model in a three-dimensional space;

a rendering processing unit that renders the first three-dimensional model using a position and a posture of each one of the plurality of virtual cameras to generate a plurality of rendering images; and

a three-dimensional model generation unit that generates the second three-dimensional model using the position and the posture of each one of the plurality of virtual cameras and each one of the plurality of rendering images.

### Supplementary Note 8

A three-dimensional model generation method including:

a virtual camera arrangement step of arranging a plurality of virtual cameras in such a way as to image a first three-dimensional model in a three-dimensional space;

a rendering processing step of rendering the first three-dimensional model using a position and a posture of each one of the plurality of virtual cameras to generate a plurality of rendering images; and

a three-dimensional model generation step of generating a second three- dimensional model using the position and the posture of each one of the plurality of virtual cameras and each one of the plurality of rendering images.

### Supplementary Note 9

The three-dimensional model generation method according to Supplementary Note 8, in which

in the virtual camera arrangement step, the plurality of virtual cameras is arranged in such a way that the first three-dimensional model is within a field of view of rendering.

### Supplementary Note 10

The three-dimensional model generation method according to Supplementary Note 8, in which

in the virtual camera arrangement step, a part or all of the plurality of virtual cameras is arranged in such a way that a portion other than the first three-dimensional model in the three-dimensional space is included in a part or all of the plurality of rendering images.

### Supplementary Note 11

The three-dimensional model generation method according to Supplementary Note 8, in which

the first three-dimensional model is three-dimensional point cloud data, and

in the rendering processing step, rendering is executed assuming that each point constituting the three-dimensional point cloud data is a solid.

### SUPPLEMENTARY NOTE 12

The three-dimensional model generation method according to Supplementary Note 8, in which

in the three-dimensional model generation step, the second three-dimensional model is generated by inputting the position and the posture of each one of the plurality of virtual cameras and each one of the plurality of rendering images to a machine learning model capable of generating a three-dimensional model.

### Supplementary Note 13

An image display method including:

a data selection step of selecting, in accordance with a user's operation that has been input, one of a first three-dimensional model or a second three-dimensional model that has been created for the same target as the first three-dimensional model and has a smaller amount of data than the first three-dimensional model;

a processing execution step of executing processing corresponding to the operation on the selected three-dimensional model; and

a presentation step of presenting a result of the processing.

### Supplementary Note 14

The image display method according to Supplementary Note 13, further including:

a virtual camera arrangement step of arranging a plurality of virtual cameras in such a way as to image the first three-dimensional model in a three-dimensional space;

a rendering processing step of rendering the first three-dimensional model using a position and a posture of each one of the plurality of virtual cameras to generate a plurality of rendering images; and

a three-dimensional model generation step of generating the second three-dimensional model using the position and the posture of each one of the plurality of virtual cameras and each one of the plurality of rendering images.

### Supplementary Note 15

A computer-readable recording medium recording a program including

an instruction for causing a computer to execute:

a virtual camera arrangement step of arranging a plurality of virtual cameras in such a way as to image a first three-dimensional model in a three-dimensional space;

a rendering processing step of rendering the first three-dimensional model using a position and a posture of each one of the plurality of virtual cameras to generate a plurality of rendering images; and

a three-dimensional model generation step of generating a second three-dimensional model using the position and the posture of each one of the plurality of virtual cameras and each one of the plurality of rendering images.

### Supplementary Note 16

The computer-readable recording medium according to Supplementary Note 15, in which

in the virtual camera arrangement step, the plurality of virtual cameras is arranged in such a way that the first three-dimensional model is within a field of view of rendering.

### Supplementary Note 17

The computer-readable recording medium according to Supplementary Note 15, in which

in the virtual camera arrangement step, a part or all of the plurality of virtual cameras is arranged in such a way that a portion other than the first three-dimensional model in the three-dimensional space is included in a part or all of the plurality of rendering images.

### Supplementary Note 18

The computer-readable recording medium according to Supplementary Note 15, in which

the first three-dimensional model is three-dimensional point cloud data, and

in the rendering processing step, rendering is executed assuming that each point constituting the three-dimensional point cloud data is a solid.

### Supplementary Note 19

The computer-readable recording medium according to Supplementary Note 15, in which

in the three-dimensional model generation step, the second three-dimensional model is generated by inputting the position and the posture of each one of the plurality of virtual cameras and each one of the plurality of rendering images to a machine learning model capable of generating a three-dimensional model.

### Supplementary Note 20

A computer-readable recording medium recording a program including

an instruction for causing a computer to execute:

a data selection step of selecting, in accordance with a user's operation that has been input, one of a first three-dimensional model or a second three-dimensional model that has been created for the same target as the first three-dimensional model and has a smaller amount of data than the first three-dimensional model;

a processing execution step of executing processing corresponding to the operation on the selected three-dimensional model; and

a presentation step of presenting a result of the processing.

### Supplementary Note 21

The computer-readable recording medium according to Supplementary Note 20, in which

the program further includes

an instruction for causing the computer to execute:

a virtual camera arrangement step of arranging a plurality of virtual cameras in such a way as to image the first three-dimensional model in a three-dimensional space;

a rendering processing step of rendering the first three-dimensional model using a position and a posture of each one of the plurality of virtual cameras to generate a plurality of rendering images; and

a three-dimensional model generation step of generating the second three-dimensional model using the position and the posture of each one of the plurality of virtual cameras and each one of the plurality of rendering images.

According to the present disclosure, it is possible to reduce the amount of data while suppressing a decrease in accuracy in a three-dimensional model. The present disclosure is useful for a computer system that handles three-dimensional models.

1. A three-dimensional model generation apparatus comprising:
at least one memory storing instructions; and
at least one processor configured to execute the instructions to:
arrange a plurality of virtual cameras in such a way as to image a first three-dimensional model in a three-dimensional space;
render the first three-dimensional model using a position and a posture of each one of the plurality of virtual cameras to generate a plurality of rendering images; and
generate a second three-dimensional model using the position and the posture of each one of the plurality of virtual cameras and each one of the plurality of rendering images.

2. The three-dimensional model generation apparatus according to claim 1, wherein
at least one processor arranges the plurality of virtual cameras in such a way that the first three-dimensional model is within a field of view of rendering.

3. The three-dimensional model generation apparatus according to claim 1, wherein
at least one processor arranges a part or all of the plurality of virtual cameras in such a way that a portion other than the first three-dimensional model in the three-dimensional space is included in a part or all of the plurality of rendering images.

4. The three-dimensional model generation apparatus according to claim 1, wherein
the first three-dimensional model is three-dimensional point cloud data, and
at least one processor executes rendering assuming that each point constituting the three-dimensional point cloud data is a solid.

5. The three-dimensional model generation apparatus according to claim 1, wherein
at least one processor generates the second three-dimensional model by inputting the position and the posture of each one of the plurality of virtual cameras and each one of the plurality of rendering images to a machine learning model capable of generating a three-dimensional model.

6. A three-dimensional model generation method executed by a computer,
the three-dimensional model generation method comprising:
arranging a plurality of virtual cameras in such a way as to image a first three-dimensional model in a three-dimensional space;
rendering the first three-dimensional model using a position and a posture of each one of the plurality of virtual cameras to generate a plurality of rendering images; and
generating a second three-dimensional model using the position and the posture of each one of the plurality of virtual cameras and each one of the plurality of rendering images.

7. The three-dimensional model generation method according to claim 6, wherein
the arranging the virtual cameras includes arranging the plurality of virtual cameras in such a way that the first three-dimensional model is within a field of view of rendering.

8. The three-dimensional model generation method according to claim 6, wherein
the arranging the virtual cameras includes arranging a part or all of the plurality of virtual cameras in such a way that a portion other than the first three-dimensional model in the three-dimensional space is included in a part or all of the plurality of rendering images.

9. The three-dimensional model generation method according to claim 6, wherein
the first three-dimensional model is three-dimensional point cloud data, and
the rendering includes executing rendering assuming that each point constituting the three-dimensional point cloud data is a solid.

10. The three-dimensional model generation method according to claim 6, wherein
the generating the three-dimensional model includes generating the second three-dimensional model by inputting the position and the posture of each one of the plurality of virtual cameras and each one of the plurality of rendering images to a machine learning model capable of generating a three-dimensional model.

11. A non-transitory computer-readable recording medium recording a program for causing
a computer to:
arrange a plurality of virtual cameras in such a way as to image a first three-dimensional model in a three-dimensional space;
render the first three-dimensional model using a position and a posture of each one of the plurality of virtual cameras to generate a plurality of rendering images; and
generate a second three-dimensional model using the position and the posture of each one of the plurality of virtual cameras and each one of the plurality of rendering images.

12. The non-transitory computer-readable recording medium according to claim 11, wherein
the program causes the computer to:
when arranging the virtual cameras, arrange the plurality of virtual cameras in such a way that the first three-dimensional model is within a field of view of rendering.

13. The non-transitory computer-readable recording medium according to claim 11, wherein
the program causes the computer to:
when arranging the virtual cameras, arrange a part or all of the plurality of virtual cameras in such a way that a portion other than the first three-dimensional model in the three-dimensional space is included in a part or all of the plurality of rendering images.

14. The non-transitory computer-readable recording medium according to claim 11, wherein
the first three-dimensional model is three-dimensional point cloud data, and
the program causes the computer to:
in the rendering, execute rendering assuming that each point constituting the three-dimensional point cloud data is a solid.

15. The non-transitory computer-readable recording medium according to claim 11, wherein
the program causes the computer to:
when generating the three-dimensional model, generate the second three-dimensional model by inputting the position and the posture of each one of the plurality of virtual cameras and each one of the plurality of rendering images to a machine learning model capable of generating a three-dimensional model.
